(19) United States
(12) Patent Application Publication
(10) Pub. No.: US 2009/0037432 A1
(43) Pub. Date: Feb. 5, 2009

(54) INFORMATION COMMUNICATION SYSTEM AND DATA SHARING METHOD

(75) Inventors: Koichiro Kamura, Fujisawa-shi (JP); Hiroshi Nakajima, Nishitokyo-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 12/181,637

(22) Filed: Jul. 29, 2008

(30) Foreign Application Priority Data
Jul. 31, 2007 (JP) 2007-199369

(51) Int. Cl. G06F 17/30

(52) U.S. Cl. 707/10; 707/E17.005

(57) ABSTRACT

According to one embodiment, a data sharing method for an information communication system in which a plurality of nodes that belong to a self group are connected to a network, the method includes sending, via the network, a node confirmation request to remaining nodes to confirm availabilities of the remaining nodes that belong to the self group, receiving node confirmation response messages including information indicating the availabilities from the remaining nodes, setting parameters N and M in accordance with contents of the node confirmation response messages, dividing shared data into N divided data, and M-fold distributing and storing the divided data of the shared data in N nodes, selectively collecting N divided data from not less than (N−M+1) nodes, and restoring the shared data by combining the collected N divided data.

### CROSS-REFERENCE TO RELATED APPLICATIONS

This application is based upon and claims the benefit of priority from Japanese Patent Application No. 2007-199369, filed Jul. 31, 2007, the entire contents of which are incorporated herein by reference.

### BACKGROUND

1. Field

One embodiment of the present invention relates to an information communication system and data sharing system, which allow a plurality of nodes to share data.

2. Description of the Related Art

Many companies and departments do not use any servers. However, most companies and departments do use personal computers in their businesses. Conventionally, there are few information communication systems which can provide high convenience suitable for businesses of work groups and allow sharing of highly confidential data for companies that use only personal computers without any servers.

Jpn. Pat. Appln. KOKAI Publication No. 2004-94681 discloses a technique in which first to n-th computers are connected via a network, a database is divided into first to n-th slots, the first to n-th slots are stored in the respective computers as master slots, and copies of the master slots are stored in a storage unit different from that which stores the master slots.

With the aforementioned technique, data can be restored if one computer has gone wrong. The aforementioned technique assumes that the first to n-th computers are servers. Therefore, it is difficult for departments which cannot use any servers to exploit the aforementioned technique.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing the arrangement of an information communication system according to one embodiment of the invention;

FIG. 2 is an exemplary block diagram showing the arrangement of a node shown in FIG. 1;

FIG. 3 is an exemplary view showing an example in which data is divided into eight, and the divided data are quadruply distributed to and stored in eight nodes;

FIG. 4 is an exemplary view showing an example in which original data is restored while three nodes are not connected to a network;

FIG. 5 is an exemplary view showing an example of the basic format of a WGS protocol message;

FIG. 6 is an exemplary view showing an example of message IDs shown in FIG. 5;

FIG. 7 is an exemplary view showing an example of a list of parameters used in the WGS message;

FIG. 8 is an exemplary view showing an example of sub-parameters that configure “Node Availability Info”;

FIG. 9 is an exemplary view showing an example of a node confirmation request message;

FIG. 10 is an exemplary view showing an example of a node confirmation response message;

FIG. 11 is an exemplary view showing an example of a divided data delivery message;

FIG. 12 is an exemplary view showing an example of a divided data assignment list delivery message;

FIG. 13 is an exemplary view showing an example of a divided data assignment list request message;

FIG. 14 is an exemplary view showing an example of a divided data assignment list response message;

FIG. 15 is an exemplary view showing an example of a divided data transfer request message;

FIG. 16 is an exemplary view showing an example of a divided data transfer response message;

FIG. 17 is an exemplary view showing an example of a group registration request message;

FIG. 18 is an exemplary view showing an example of a group registration response message;

FIG. 19 is an exemplary chart showing an example of the operation sequence upon data storage;

FIG. 20 is an exemplary chart showing an example of the operation sequence upon data restoration;

FIG. 21 is an exemplary block diagram showing an example of the arrangement of a personal computer according to the first embodiment;

FIG. 22 is an exemplary view showing an example of a work group type file sharing system according to the first embodiment;

FIG. 23 is an exemplary view showing an example of a work group type file sharing system according to the second embodiment; and

FIG. 24 is an exemplary view showing an example of a work group type file sharing system according to the third embodiment.

### DETAILED DESCRIPTION

Various embodiments according to the invention will be described hereinafter with reference to the accompanying drawings. In general, according to one embodiment of the invention, an information communication system in which a plurality of nodes that belong to a self group are connected to a network, each of the plurality of nodes comprising, a node confirmation unit configured to send, via the network, a node confirmation request to remaining nodes to confirm availabilities of the remaining nodes that belong to the self group, and to receive node confirmation response messages including information indicating the availabilities from the remaining nodes, a node confirmation response message sending unit configured to send, when the node confirmation request is received from the node confirmation unit of another node, the node confirmation response message to the node that sent the node confirmation request, a distributed storage setting unit configured to set parameters N and M in accordance with contents of the node confirmation response messages, a distributed storage unit configured to divide shared data into N divided data, and to M fold distribute and store the divided data of the shared data in N nodes, a divided data collection unit configured to selectively collect N divided data from not less than (N−M+1) nodes, a divided data transfer unit configured to transfer, in response to a request from the divided data collection unit of another node, divided data to the node that issued the request, and a data restoration unit configured to restore the shared data by combining the collected N divided data.

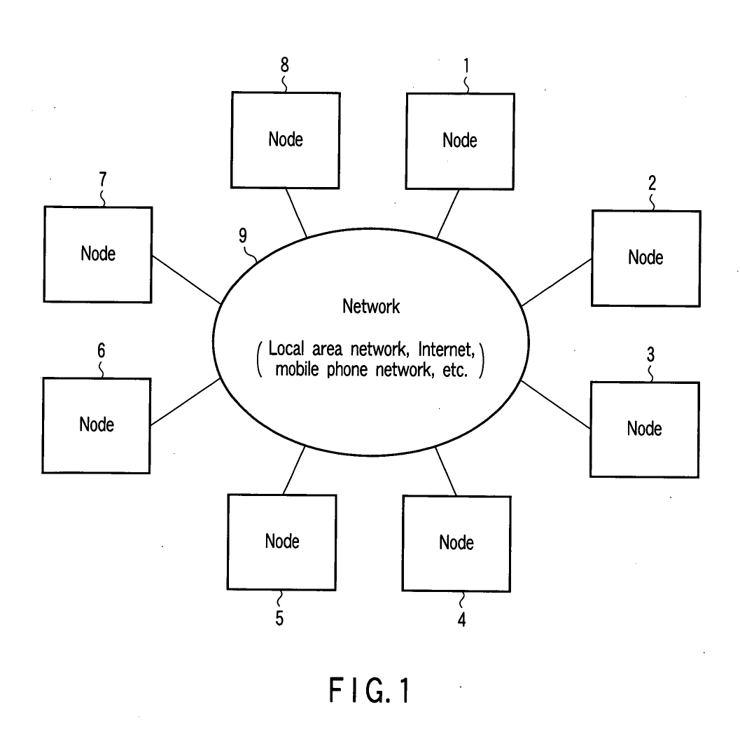

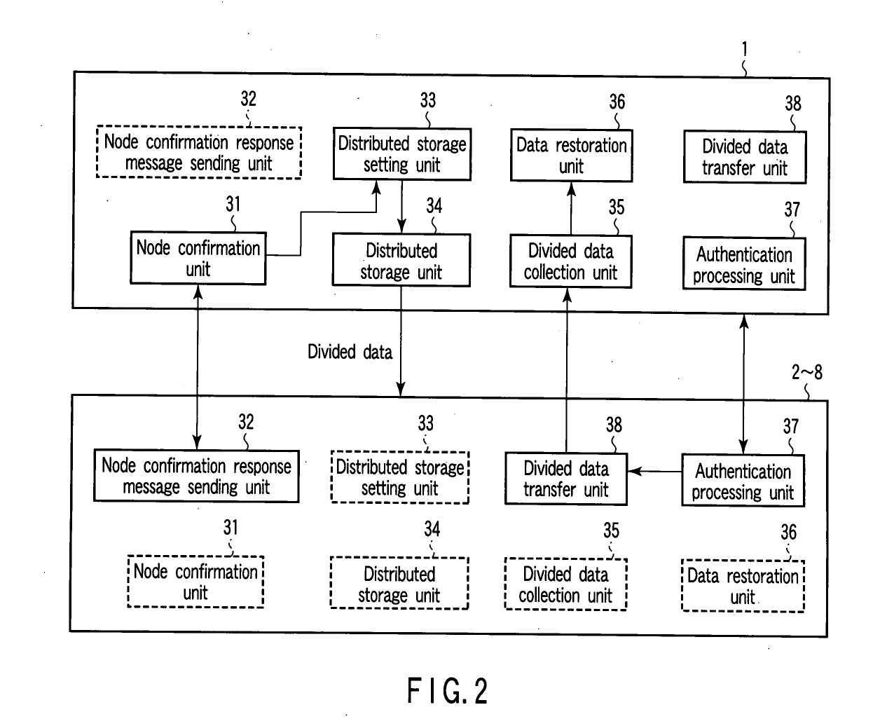

FIG. 1 is a diagram of an information communication system according to one embodiment of the invention. As shown in FIG. 1, a plurality of nodes 1 to 8 such as personal computers, servers, network storage device, and the like are connected to a network 9.

These plurality of nodes 1 to 8 can communicate with each other via the network 9 such as an office LAN (wired or wireless LAN), the Internet, a mobile communication network, or the like.

In the information communication system according to this embodiment, N nodes 1 to 8 build up a virtual shared disk on the network by providing some or all areas of their hard disk drives, and distribute and save data, which are commonly used by the N nodes 1 to 8 in the shared disk.

Each node comprises a node confirmation unit 31, node confirmation response message sending unit 32, distributed storage setting unit 33, distributed storage unit 34, divided data collection unit 35, data restoration unit 36, authentication processing unit 37, divided data transfer unit 38, and the like.

The node confirmation unit 31 sends a node confirmation request to other nodes which belong to the self group via the network 9 so as to confirm the availability of these nodes, and receives node confirmation response messages each including information indicating the availability from these nodes. The respective nodes 1 to 8 comprise node confirmation units 31, but the node confirmation unit 31 of only a node set as a master is active. In this embodiment, assume that the node 1 is set as a master.

Upon reception of the node confirmation request from the node confirmation unit 31 of the node 1 set as a master, the node confirmation response message sending unit 32 sends a node confirmation response message including information indicating the availability of the self node to the node confirmation unit 31 of the node 1.

Upon storing data in the aforementioned virtual shared disk, the distributed storage setting unit 33 sets how to distribute and store data. The distributed storage setting unit 33 decides settings using at least the availability information included in the node confirmation response message. The distributed storage setting unit 33 sends setting information to the respective nodes, which store the setting information in the self nodes.

The distributed storage unit 34 divides shared data into N divided data on the basis of the settings decided by the distributed storage setting unit 33, and M-fold distributes and stores the N divided data in N nodes.

The divided data collection unit 35 selectively collects N N-divided data from (N−M+1) or more nodes 2 to 8. At this time, upon collecting divided data which is not stored in the self node, the divided data collection unit 35 sends a divided data transfer request to other nodes. Upon reception of the divided data transfer request, the divided data transfer units 38 of other nodes 2 to 8 send divided data requested by the divided data collection unit 35 to the node 1 which sent the divided data transfer request.

Note that prior to transfer of divided data of the divided data transfer unit 38, the authentication processing unit 37 executes authentication processing with the node which sent the divided data transfer request. When the authentication processing has succeeded, the divided data transfer unit 38 transfers divided data. Note that divided data may be transferred while skipping the authentication processing. However, the authentication processing is preferably executed in terms of security.

The data restoration unit 36 combines the N divided data selectively collected by the divided data collection unit 35 to restore original data.

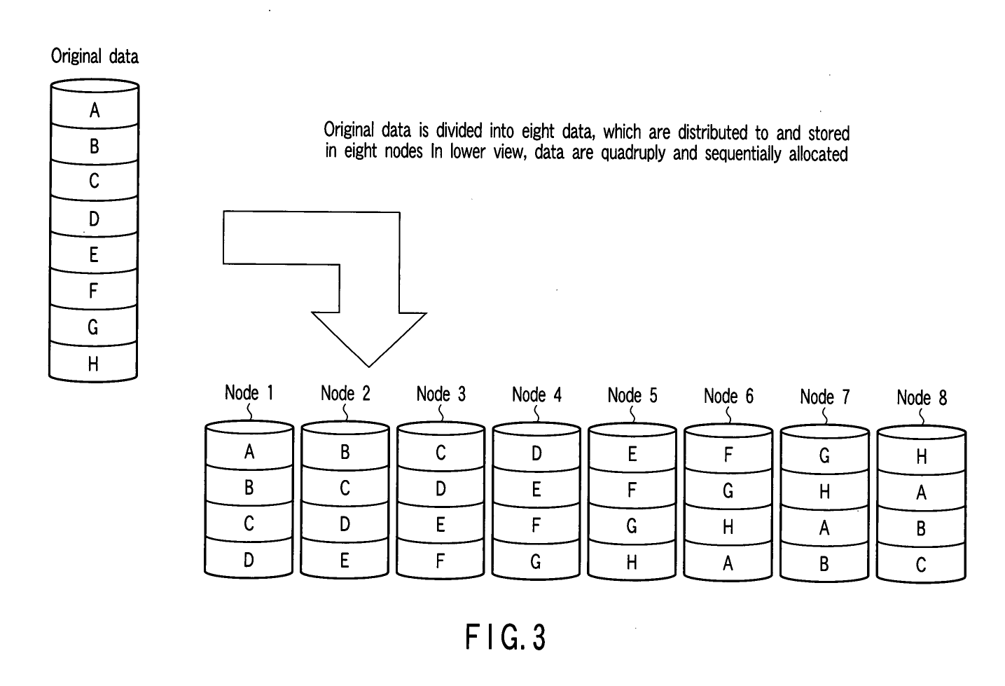

FIG. 3 shows an example (N=8, M=4) of distributed storage of data. As shown in FIG. 3, node x (x: one of 1 to 8) generates original data, and divides the original data into eight divided data A to H based on the settings of the distributed storage setting unit 33. After that, node x quadruply distributes and stores the divided data A to H in other nodes based on the settings of the distributed storage setting unit 33.

In this example, node x delivers data so that the node 1 stores the data A to D, the node 2 stores the data B to E, the node 3 stores the data C to F, and the nodes 4 to 8 similarly store four divided data of different combinations.

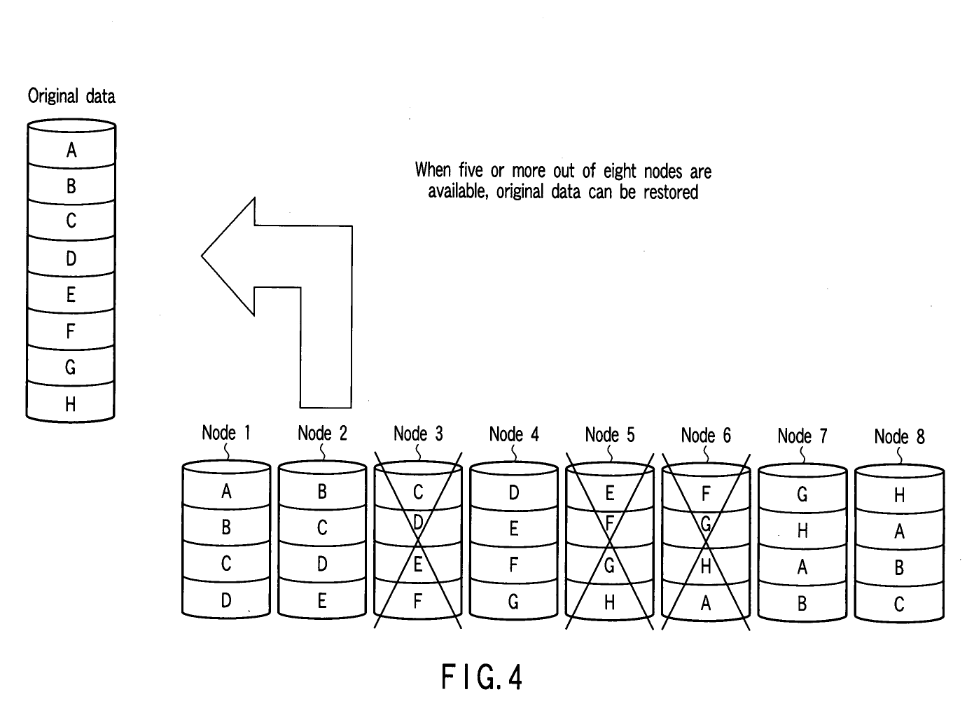

The sequence for restoring the original data from the divided data stored in the aforementioned sequence will be described below. FIG. 4 shows a case in which node x restores original data from the divided data, which were quadruply distributed to and stored in the eight nodes 1 to 8. This example shows a case in which three nodes (nodes 3, 5, and 6) are not connected to the network.

As can be seen from FIG. 4, node x cannot refer to or receive the divided data (C, D, E, F) stored in the node 3, those (E, F, G, H) stored in the node 5, and those (F, G, H, A) stored in the node 6 from the nodes 3, 5, and 6 via the network.

However, as can be seen from FIG. 4, node x can refer to or receive:

the divided data C from one of the nodes 1, 2, and 8;

the divided data D from one of the nodes 1, 2, and 4;

the divided data E from one of the nodes 2 and 4;

the divided data F from the node 4;

the divided data G from one of the nodes 4 and 7;

the divided data H from one of the nodes 7 and 8;

the divided data A from one of the nodes 1, 7, and 8; and

the divided data B from one of the nodes 1, 2, and 7.

Therefore, node x can collect a total of eight divided data A to H from the remaining four nodes connected to the network.

In this manner, when original information is divided into N pieces of divided information, and M out of N pieces of divided information are stored in each of the N nodes, the original information can be restored if (N−M+1) or more nodes are available.

Exchanges among the nodes in the aforementioned information processing system will be described below. Note that such exchanges of messages among the nodes will be referred to as a WGS (Work Group Sharing) protocol hereinafter for the sake of convenience. The WGS protocol belongs to an upper layer of a TCP protocol.

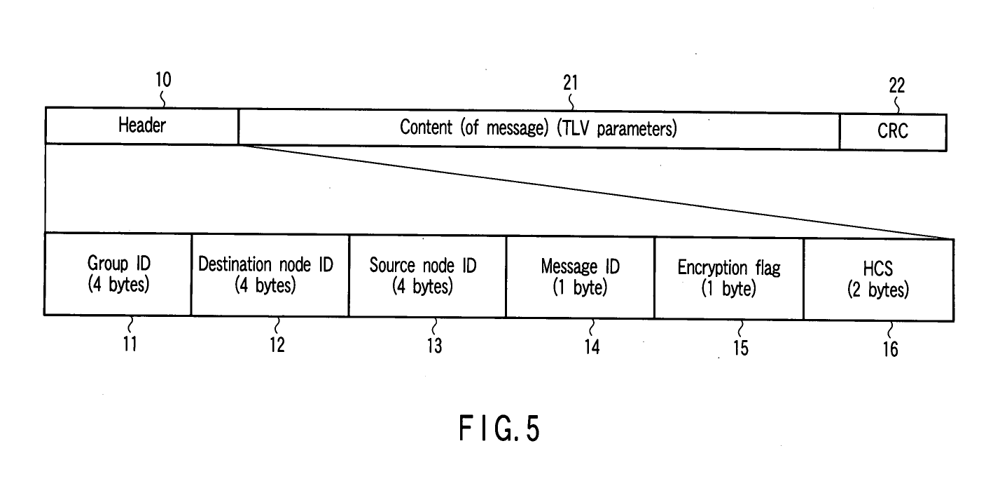

FIG. 5 shows the basic format of a WGS protocol message. As shown in FIG. 5, the WGS protocol message is configured by a header 10 which includes, as fields, a group ID 11, destination node ID 12, source node ID 13, message ID 14, encryption flag 15, and HCS (Header Check Sequence) 16, a content 21 of the message including various parameters, and a CRC 22.

The group ID 11 is an identifier used to identify a group to which the nodes in the information processing system belong, and is uniquely set in this information processing system. This group ID 11 may be set according to the affiliations of users in this information processing system or an application program may automatically assign the group ID 11 for each meeting in a work group type shared file system (to be described later). Each node can enter or secede from the group in the sequence to be described later. Each node is assigned a node ID uniquely defined in this information processing system. This node ID may be uniquely assigned in this system or an IP address may substitute the node ID.

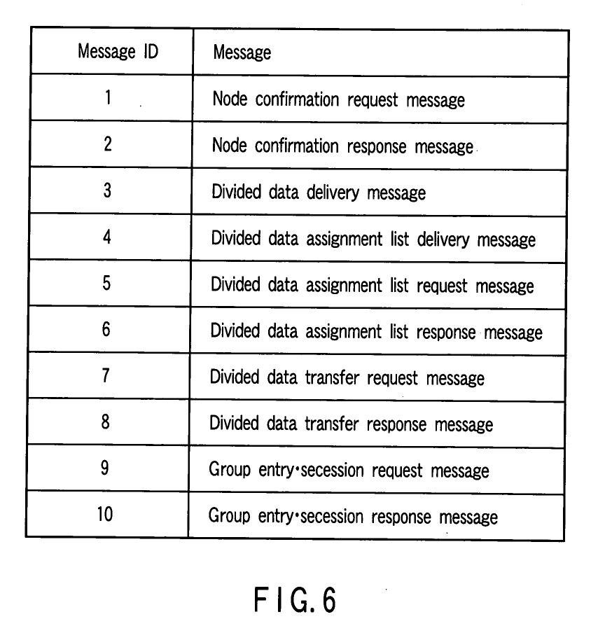

The message ID 14 is an identifier used to identify messages (e.g., 10 different messages shown in FIG. 6) to be exchanged in the WGS protocol. As shown in FIG. 6, these messages include a “node confirmation request message”, “node confirmation response message”, “divided data delivery message”, “divided data assignment list delivery message”, “divided data assignment list request message”, “divided data assignment list response message”, “divided data transfer request message”, “divided data transfer response message”, “group entrysecession request message”, and “group entrysecession response message”.

The encryption flag 15 indicates whether or not the content 21 of the message is encrypted. When the content 21 is encrypted, the encryption flag 15 allows to identify an encryption method such as DES or the like and its version. The HCS 16 is data used to check if data in the fields in the header have suffered errors on a transmission path. On the other hand, the content of the message may be expressed in a format in which each individual parameter may be expressed using a TLV (Type, Length, Value) format, and required parameter are coupled according to the message ID.

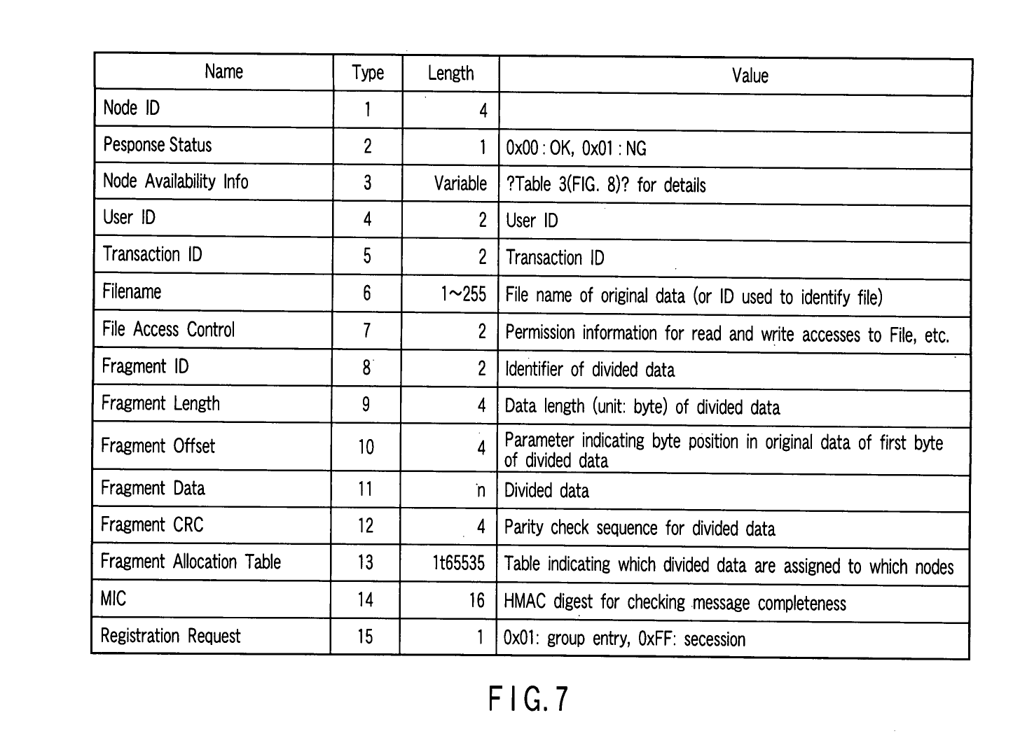

FIG. 7 shows a list of parameters used in the WGS message. As shown in FIG. 7, the parameters include “Node ID”, “Response Status”, “Node Availability Info”, “User ID”, “Transaction ID”, “Filename”, “File Access Control”, “Fragment ID”, “Fragment Length”, “Fragment Offset”, “Fragment Data”, “Fragment CRC”, “Fragment Allocation Table”, “MIC”, and “Registration Request”.

In FIG. 7, “Node Availability Info” is a parameter which indicates the node availability, and has a significant role in the node confirmation unit 31 and node confirmation response message sending unit 32. For example, when each node comprises a personal computer, that personal computer is not always ON and is not always connected to the network. Personal computers encounter various situations: there is no space for saving sharing data, an application such as an IP phone which requires realtimeness is in use, another important job is in execution and is not to be influenced by saving of sharing data, and so forth.

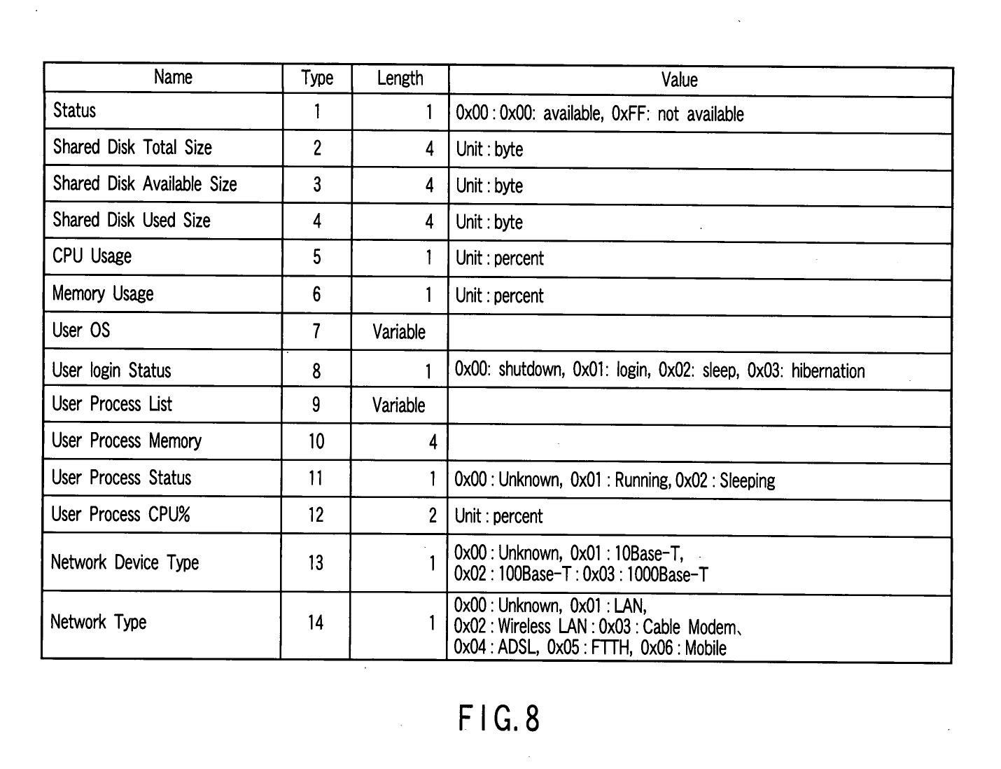

“Node Availability Info” is information used to confirm such situations of each node, and can be configured by information as a combination of sub-parameters shown in FIG. 8. As shown in a table in FIG. 8, “Node Availability Info” is characterized by using not only information associated with a shared disk provided by each node but also information such as the operating system name of software used by the user of the personal computer, the user login state, the names and statuses of processes (applications) that run on the personal computer, the memory usage, the CPU usage, the type of network device, the type of network (office LAN, wireless LAN, cable modem, ADSL, FTTH, mobile network, and the like), and so forth at that node, in correspondence with features of the node and system.

Also, “Filename” is the file name of original data or an ID used to identify a file. “File Access Control” is permission information for read and write accesses and the like to a file. “Fragment ID” is an identifier of divided data: for example, it is numbered like 1, 2, 3, . . . in turn from a first file. “Fragment Length” is the data length of divided data. “Fragment Offset” is a parameter indicating the byte position of the first byte of divided data in original data. “Fragment Data” is actual fragment data. “Fragment CRC” is a parity check sequence for divided data. “Fragment Allocation Table” is a table indicating nodes to which divided data are assigned. “MIC” is an HMAC digest used to check completeness of a message. “Registration Request” indicates entry to a group if it is “0×01” or secession from a group if it is “0×FF”.

An overview of messages used in the WGS protocol will be described below.

[Node Confirmation Request Message]

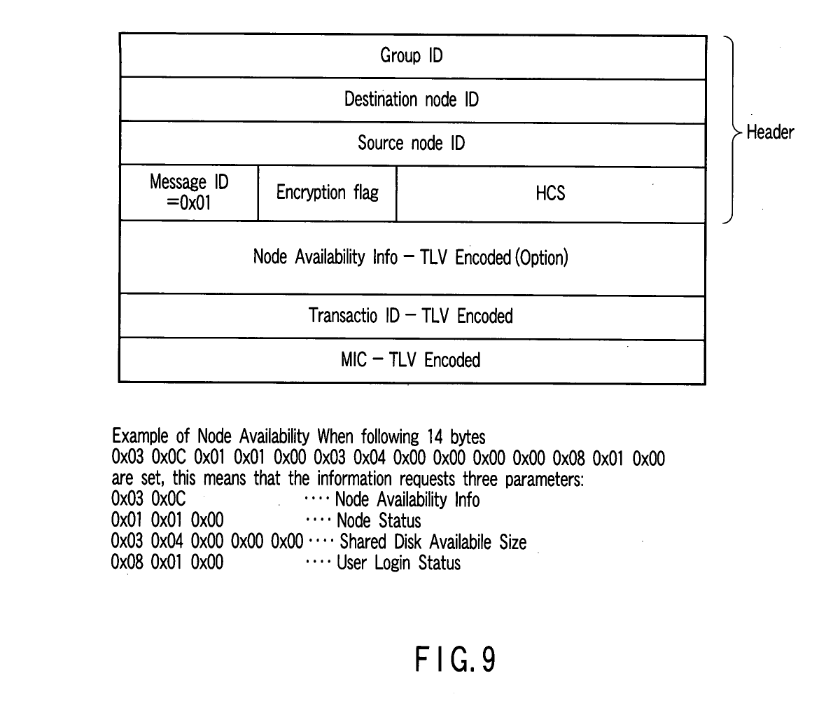

FIG. 9 shows an example of a node confirmation request message. This node confirmation request message is used to confirm (check) the availability of nodes upon storing and reconstructing sharing data. The group ID to which this node belongs is set in a group ID in a header shown in FIG. 9, and individual node IDs may be set in a destination node ID. Upon issuing the request to all nodes in the group, “0×FF”, “0×FF”, “0×FF”, and “0×FF” may be set in the destination node ID. A value (0×01) indicating the node confirmation request message is set in a message ID field.

On the other hand, in contents fields, parameters called “Node Availability Info” are described in the TLV format. This indicates which of the “Node Availability Info” parameters shown in FIG. 8 are required (requested). For example, if the following 14-byte value is set in this “Node Availability Info” field, it is requesting a destination node to return three pieces of information: “Status”, “Shared Disk Available Size”, and “User Login Status”. Which parameters are to be required may be dynamically determined in correspondence with features of nodes and systems or may be set in advance by a system administrator.

“0×03 0×0C 0×01 0×01 0×00 0×03 0×04 0×00 0×00 0×00 0×00 0×08 0×01 0×00”

The first byte “0×03” indicates the type of “Node Availability Info”. The second byte “0×0C” indicates that the length of a parameter that follows is 12 bytes. The third byte “0×01” indicates “Status”. The fourth byte indicates the number of bytes of a “Status” field. The fifth byte indicates a Status value=“0×00”, the sixth byte indicates a sub-type “0×03”, i.e., “Shared Disk Available Size”, the seventh byte indicates the field length=4 bytes of “Shared Disk Available Size”, the eighth to 11th bytes indicate a value=0, the 12th byte indicates a sub-type=“0×08”, i.e., “User Login Status”, and the 13th and 14th bytes indicate that the “User Login Status” field length is 1 byte, and its value is zero.

In this manner, as a characteristic feature, required parameters are designated from various parameters that can indicate the availability of each node to send an inquiry to each destination node.

As shown in FIG. 9, when the source node generates a specific number upon sending a message, and receives a plurality of response message, the generated number may be included in this request message as “Transaction ID”, to determine to which request message each response message corresponds to. Also, an MIC (Message Integration Check) parameter may include a calculated value of HMAC, MD5, or the like so as to prevent falsification of a message.

[Node Confirmation Response Message]

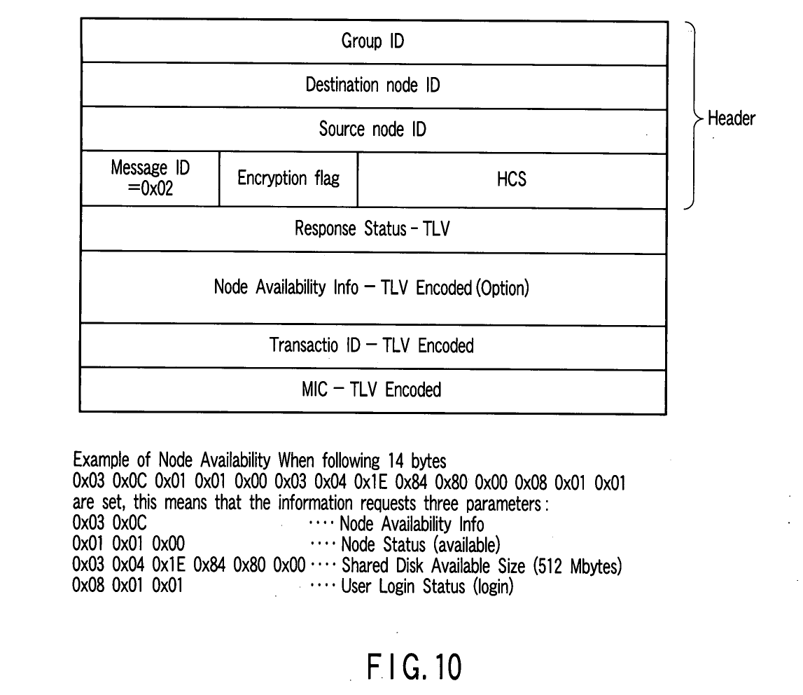

FIG. 10 shows an example of a node confirmation response message. This message is used when each node responds to the node confirmation request message. As shown in FIG. 10, “0×02” is set in a message ID field in a header. Then, a response status (OK or NG) to the node confirmation request message is set in a “Response Status” field. If the response status is OK, data is generated as “Node Availability Info” indicating information of the self node corresponding to the parameters in the requested “Node Availability Info”, and is returned using this message. For example, a case will be described below wherein the following 14 bytes are set, as in the example of FIG. 10.

0×03 0×0C 0×01 0×01 0×00 0×03 0×04 0×1E 0×84 0×80 0×00 0×08 0×01 0×01

“0×01 0×0C”: “Node Availability Info”

“0×01 0×01 0×00”: “Node Status” (available)

“0×03 0×04 0×1E 0×84 0×00”: “Shared Disk Available Size” (512 Mbytes)

“0×08 0×01 0×01”: User Login Status (login)

Note that the value of the “Transaction ID” field of the node confirmation request message may be set as that of the response message. Likewise, an MIC (Message Integration Check) parameter may include a calculated value of HMAC, MD5, or the like so as to prevent falsification of a message.

[Divided Data Delivery Message]

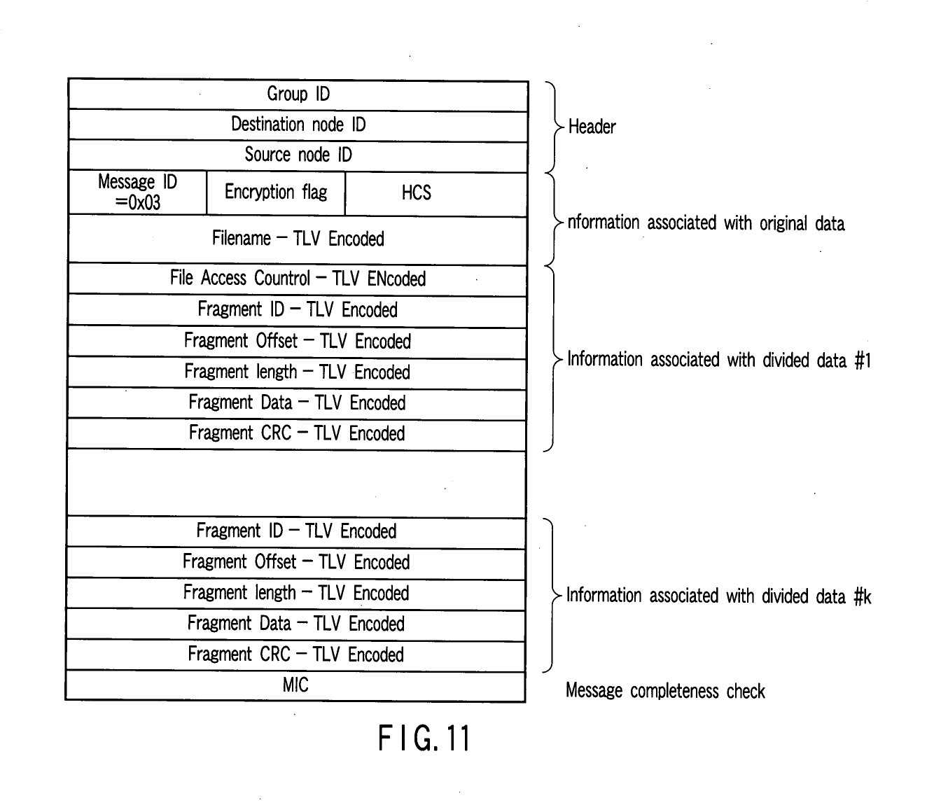

FIG. 11 shows an example of a divided data delivery message. This message is used upon delivering divided data to respective nodes. As shown in FIG. 11, “0×03” is set in a message ID field of a header. Contents fields include the file name (or an ID used to identify a file) and Access Control information of original data, and include information such as “Fragment ID” of divided data, “Fragment Offset” indicating the position in the original data, “Fragment Length” indicating the length of the divided data, “Fragment Data” indicating the divided data itself, “CRC” (Cyclic Redundancy Check) associated with the “Fragment Data” field, and the like, for each of M divided data. Also, an MIC (Message Integration Check) calculated value such as HMAC, MD5, or the like may be included so as to detect the presence/absence of falsification of data.

[Divided Data Assignment List Delivery Message]

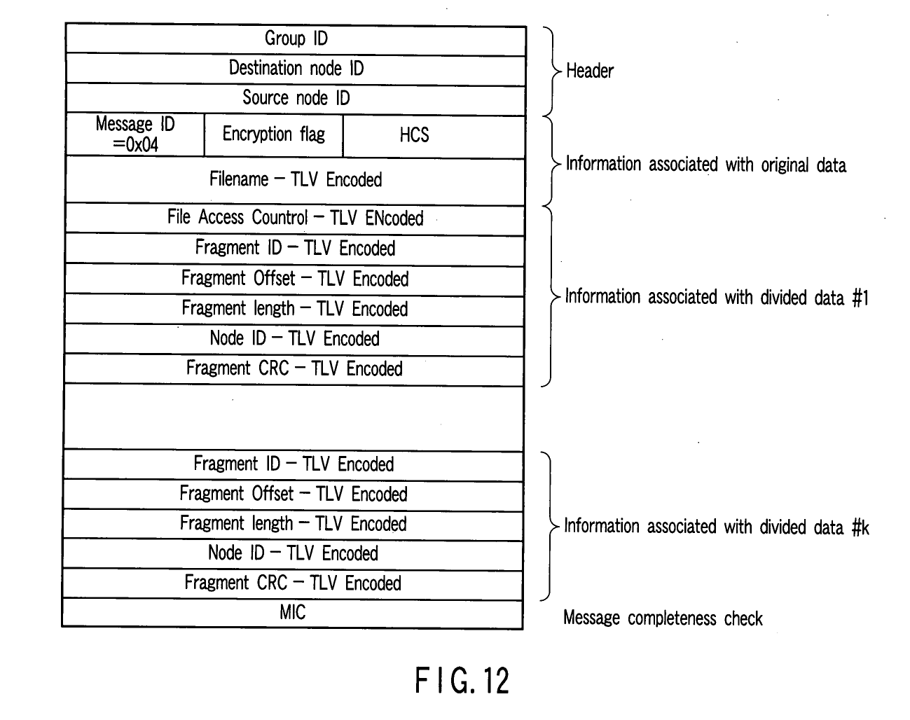

FIG. 12 shows an example of a divided data assignment list delivery message. This message is used to notify which divided data are delivered to which nodes. As shown in FIG. 12, “0×04” is set in the message ID field of a header. Upon notifying all nodes in the group, “0×FF”, “0×FF”, “0×FF”, and “0×FF” may be set in the destination node ID of the header. Contents fields include the file name (or an ID used to identify a file) and Access Control information of original data, and include information such as “Fragment ID” of divided data, “Fragment Offset” indicating the position in the original data, “Fragment Length” indicating the length of the divided data, “Node ID” indicating to which node the divided data of interest is assigned (stored), “CRC” (Cyclic Redundancy Check) associated with the “Fragment Data” field, and the like, for each of N divided data. Also, as shown in FIG. 12, a value calculated using an algorithm such as HMAC, MD5, or the like may be included as an MIC (Message Integration Check) so as to detect the presence/absence of falsification of data.

[Divided Data Assignment List Request Message]

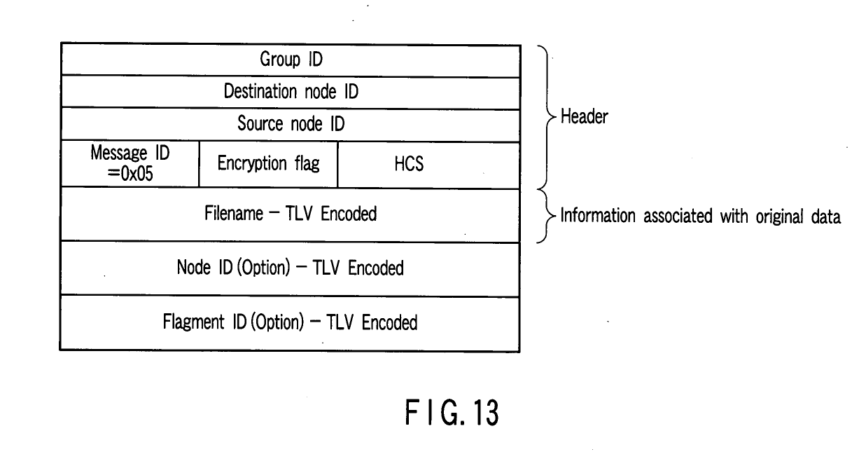

FIG. 13 shows an example of a divided data assignment list request message. This message is used when a newly activated node or a node which is to read out a file requests another node to send a divided data assignment list. When an option field includes “Node ID”, it indicates that this message requests a list of divided data held in that node. Also, when “Fragment ID” is designated in the option field, the message means to issue an inquiry as to whether or not the divided data held by that node include that designated by “Fragment ID”.

When the source node generates a specific number upon sending a message, and receives a plurality of response messages, the generated number may be included in this request message as “Transaction ID” to determine to which request message each response message corresponds.

[Divided Data Assignment List Response Message]

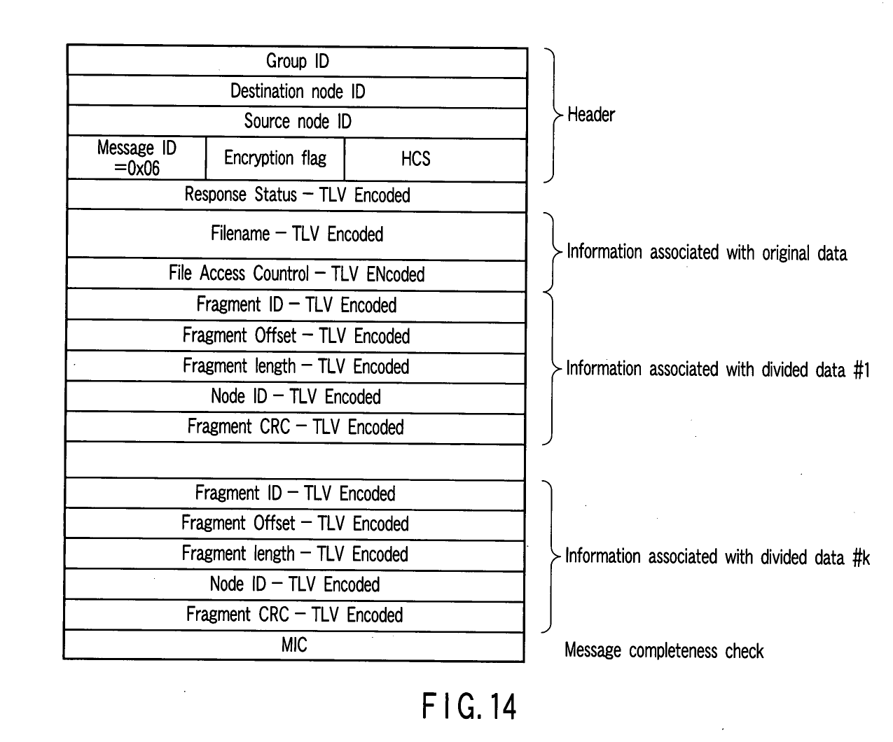

FIG. 14 shows an example of a divided data assignment list response message. This message is a response message to the divided data assignment list request message. As shown in FIG. 14, a message ID is “0×06”. The basic structure is the same as that of the divided data assignment list delivery message. However, the data assignment list delivery message includes as many pieces of assignment data as the number of divided data, N, while this message includes assignment message of partial divided data unlike the former message.

[Divided Data Transfer Request Message]

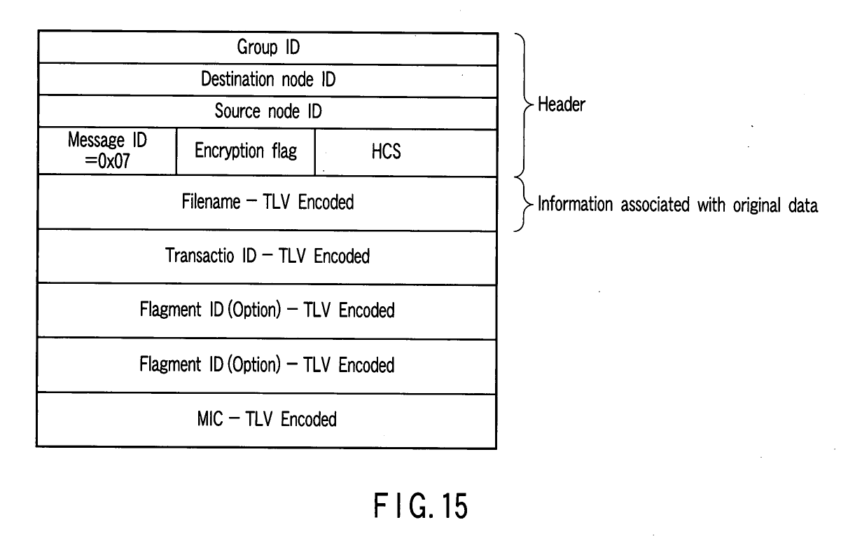

FIG. 15 shows an example of a divided data transfer request message. This message is used to request another node to send divided data. As shown in FIG. 15, a message ID is “0×07”. Contents fields include the file name of original data (or an ID used to identify a file). Furthermore, as in the example of FIG. 15, when “Fragment ID” is designated in an option field, the divided data of data held by that node and designated by “Fragment ID” can be requested to be sent.

[Divided Data Transfer Response Message]

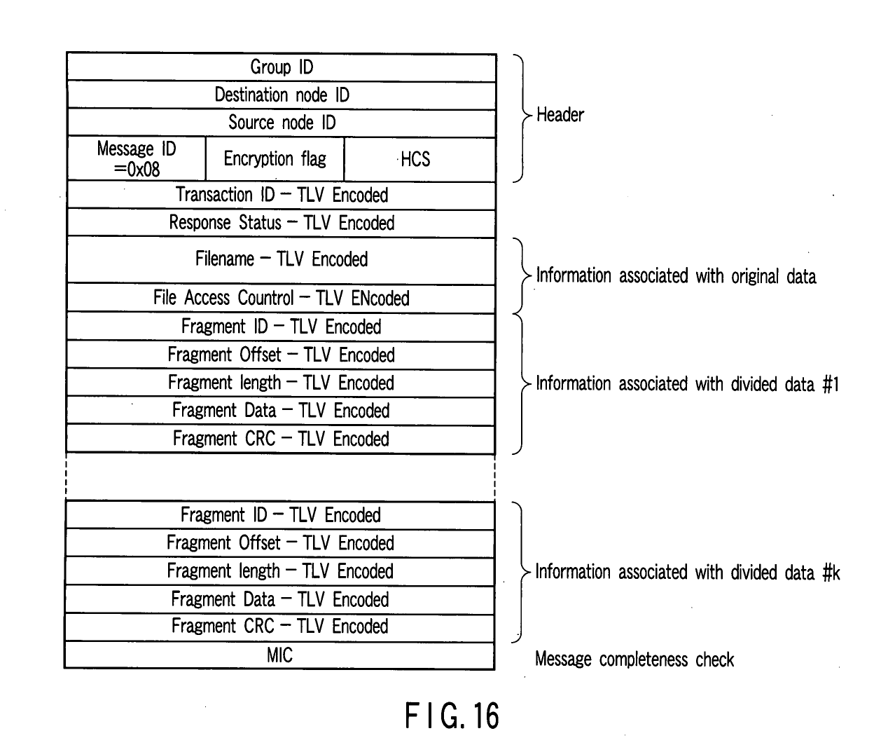

FIG. 16 shows an example of a divided data transfer response message. This message is used to return a response to the divided data transfer request message. As shown in FIG. 16, a message ID is “0×08”. Contents fields include a response status “Response Status” to the divided data transfer request. If “Response Status” is OK, the contents fields include the file name (or an ID used to identify a file) and Access Control information of original data, and also include information such as “Fragment ID” of divided data, “Fragment Offset” indicating the position in the original data, “Fragment Length” indicating the length of the divided data, Fragment Data” indicating the divided data itself, and “CRC” (Cyclic Redundancy Check) associated with the “Fragment Data” field, for each of M divided data, as shown in FIG. 16. Also, as shown in FIG. 16, an MIC (Message Integration Check) calculated value such as HMAC, MD5, or the like may be included so as to detect the presence/absence of falsification of data. On the other hand, in the case of an error (for example, the self node does not hold the requested data), a response is returned while setting “NG” in “Response Status”.

Note that the “Transaction ID” of the node confirmation request message may be that given in the response message. Likewise, an MIC (Message Integration Check) parameter may include a calculated value of HMAC, MD5, or the like so as to prevent falsification of a message.

[Group Registration Request Message]

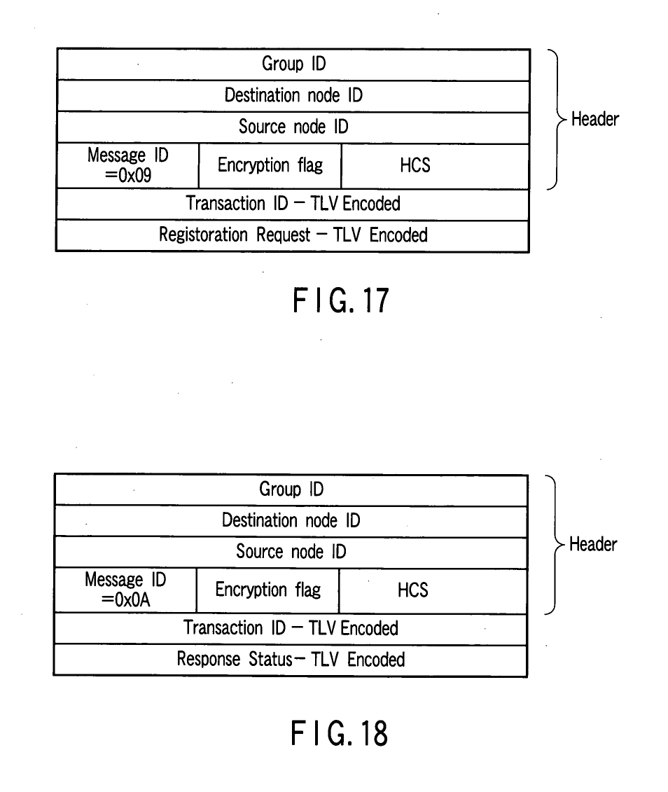

FIG. 17 shows an example of a group registration request message. This message is sent by a node when that node becomes a new group member or when it secedes from the group. Upon registering an entry as a new group member, the self node uniquely sets “Transaction ID”, and sets “0×01” as the value of “Registration Request”. Upon seceding from the group, “0×FF” is set as the value of “Registration Request”.

A group ID is an ID determined in advance in the system, and can be acquired from an administrator or from another member. Alternatively, this information can be automatically acquired by an application such as groupware or the like, i.e., by a method falling outside the scope of the invention. Upon entering a group, “0×FF”, “0×FF”, “0×FF”, and “0×FF” may be set in a destination node ID, and that message may be broadcast. After this message is sent, a response to this message is awaited.

[Group Registration Response Message]

FIG. 18 shows an example of a group registration response message. This message is used to return a response to the group registration request. As shown in FIG. 18, a response including Response status=“OK” or “NG” after “Transaction ID” is returned. The node set in advance as a master sends this message.

Interactions among the nodes will be described below with reference to the drawings.

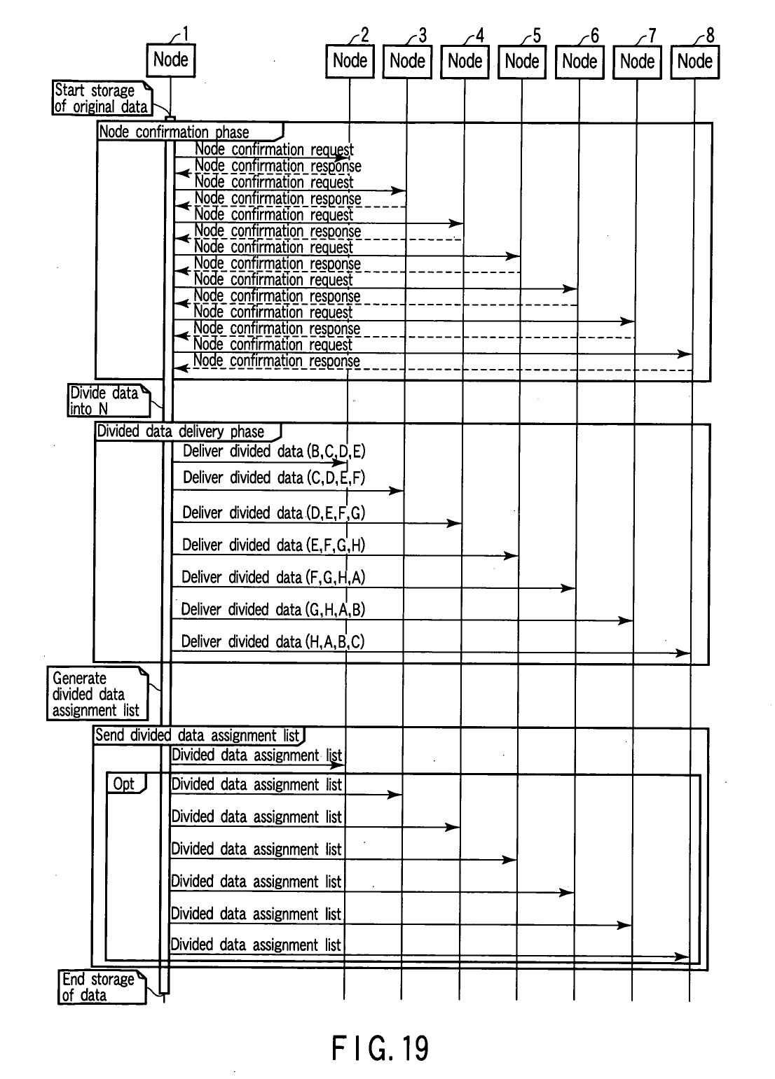

FIG. 19 shows an example of the operation sequence upon data storage. FIG. 19 shows an example in which the node 1 generates data, and distributes and stores that data to the nodes 2 to 8. As shown in FIG. 19, the node confirmation unit 31 of the node 1 sends a node confirmation request message to the nodes 2 to 8. The node confirmation response message sending units 32 of the nodes 2 to 8 check their availabilities, and send node confirmation response messages to the node 1. Upon reception of the node confirmation response messages from the nodes 2 to 8, the distributed storage setting unit 33 of the node 1 determines the number N of divisions of the data and the number M of data to be multiplexed, and determines which divided data are assigned to which nodes. After that, the distributed storage setting unit 33 delivers the data using a divided data delivery message. The divided data are delivered using a transport protocol such as TCP or the like in a lower layer. When a packet loss or the like has occurred in during delivery, packets are automatically resent. The node 1 checks the number of nodes which have failed in delivery for some reason, e.g., secession from the network or the like during the divided data delivery. If the number of nodes which have failed in delivery exceeds a predetermined value (for example, M−1), the node 1 cancels the delivery, changes the number N of divisions and the number M of data to be multiplexed of the original data, and delivers the data again.

Upon completion of the aforementioned divided data delivery, the distributed storage unit 34 sends, to other nodes, a divided data assignment list message which is generated by the distributed storage setting unit 33 and indicates which divided data are delivered to which nodes.

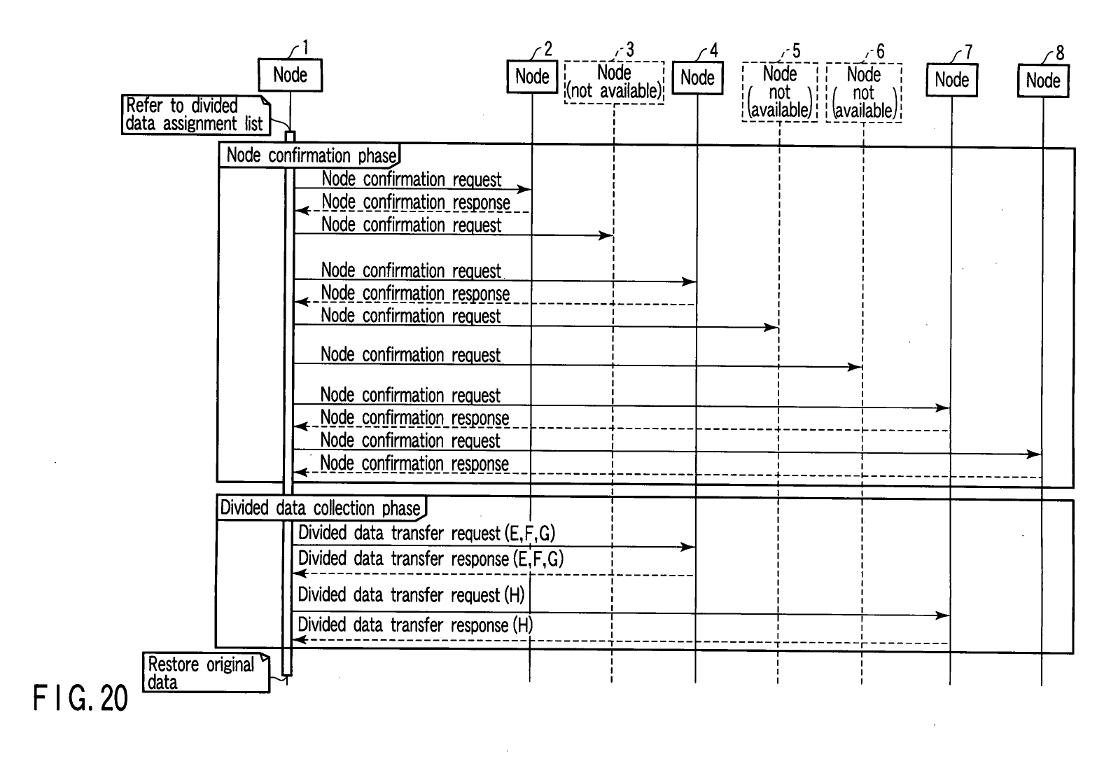

FIG. 20 shows an example of the operation sequence upon data restoration. FIG. 20 shows an example in which the nodes 3, 5, and 6 are not connected to the network 9 when the node 1 restores data. The node 1 sends a node confirmation request to all other nodes. Each of other nodes sets the parameters indicating the availability of the self node in a node confirmation response message and sends that message to the node 1. Upon reception of the node confirmation response message from the respective nodes, the divided data collection unit 35 of the node 1 selects the nodes from which data are to be collected, and sends a divided data transfer request to the selected nodes. In the example of FIG. 20, since the node 1 stores the divided data A, B, C, and D in itself, it sends, first, a divided data transfer request to the node 4 which holds most of the divided data E, F, G, and H that are not stored in the self node. After that, as for the divided data H, the node 1 compares the availabilities of the nodes 7 and 8, and sends a divided data transfer request to the node 7 which has a higher availability value. In this way, as a characteristic feature of this embodiment, upon restoring original data by collecting the divided data, optimal nodes are determined in accordance with the combinations of the divided data stored in the nodes and their availabilities.

In the example of FIG. 20, the node 1 as a master collects the divided data and restores original data. Also, each of other nodes 2 to 8 may collect the divided data to restore original data.

The principle of this system and exchange of messages among the nodes have been explained. A practical application example of this system will be described in detail below.

### FIRST EMBODIMENT

### Work Group Type File Sharing System

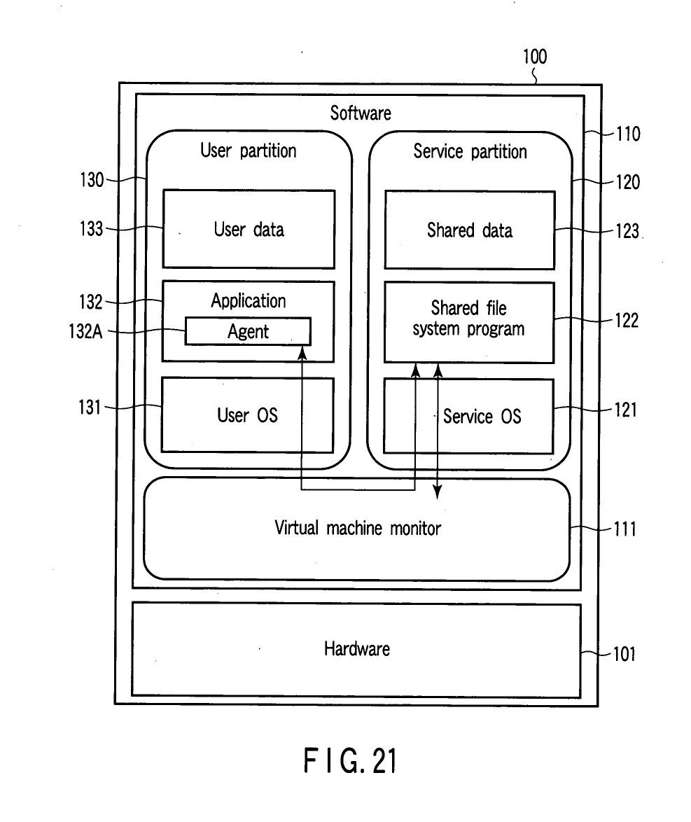

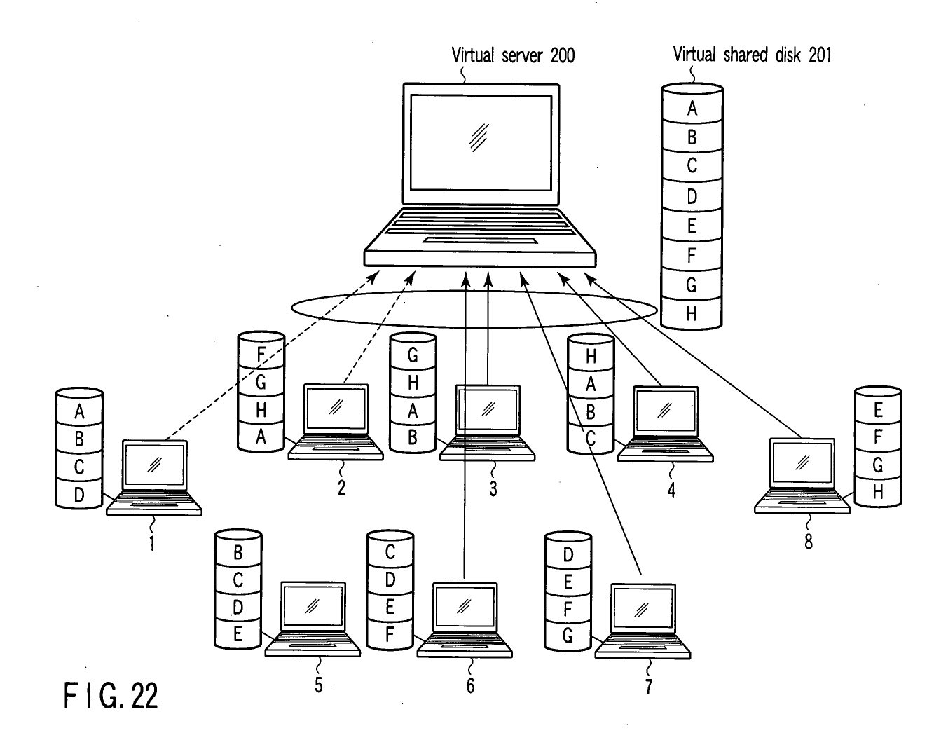

FIG. 21 shows an example of the arrangement of a personal computer according to the first embodiment of the invention, and FIG. 22 shows an example of a work group type file sharing system according to first embodiment of the invention. As shown in FIG. 21, a personal computer 100 used in this shared file system incorporates a virtual machine monitor 111 which runs on hardware 101, and software resources 110 are classified into a user partition 130 and service partition 120. The user partition 130 has a user OS 131, an application program 132 used by the user, and user data 133. The service partition 120 has a service OS 121, a shared file system program 122, and shared data 123. As a characteristic feature of this embodiment, a part to be used by the user and that to be shared by the group are completely separated. The service OS 121 inhibits direct accesses from the user partition 130 to resources such as the shared data 123 and the like in the service partition 120. The virtual machine monitor 111 is software that provides a function of allowing a plurality of virtual machines 120 and 130 to share the hardware resources of one PC and to run at the same time.

The shared file system program 122 is a program including the node confirmation unit 31, node confirmation response message sending unit 32, distributed storage setting unit 33, distributed storage unit 34, divided data collection unit 35, data restoration unit 36, authentication processing unit 37, and divided data transfer unit 38.

On the user partition 130, agent software 132A runs. The agent software 132A can check the version of the user OS 131 and information of an application (process) which is being used by the user. The agent software 132A comprises an availability information response function of responding availability information on the aforementioned user OS 131 in response to an inquiry from the shared file system program 122 which runs on the service partition 120. The shared file system program 122 generates the aforementioned node confirmation response message using this availability information response function of the agent software. In this way, a work group type file sharing system, which considers the influence on the user in accordance with the information of the application which runs on the personal computer, can be implemented.

Also, with this system, in a work group including N members, N personal computers of these members are used to M-fold distribute and store data to be shared (for example, conference minutes, digital files used in jobs, and the like) in the group, thereby sharing the data.

For example, N=8 and M=4, and each member may provide a hard disk (B=1 Gbyte) of the service partition 120 of his or her personal computer for data sharing of the group. In this way, a virtual server 200, which has a virtual shared disk 201 having a maximum capacity of N×B/M=8×¼=2 GB by collecting the hard disks provided by the respective hard disks, can be configured.

Then, as shown in FIG. 22, at a conference to which the eight members attend, with personal computers 1 to 8, they conduct the conference by referring to a digital file in the common virtual shared disk 201 using their personal computers. During or after the conference, the digital file used in the conference is distributed to and stored in the personal computers 1 to 8 of the eight members. When five out of the eight members meet each other again at a later date, and use their personal computers the saved reference can be restored.

According to this embodiment, since original information cannot be restored unless (M+1) personal computers which store distributed information are connected together after distributed storage, even if one of the eight personal computer has been stolen or lost, there is a merit that leakage of the stored information will not occur. Even when a personal computer of a given user has acquired a virus while that user uses the application on the user partition, since the shared file is stored on the service partition 120, leakage of confidential information in the shared file can be prevented. Furthermore, even when information of the shared file on the service partition side has leaked, since that shared file stores only some divided data, the confidentiality can be enhanced. Note that such high confidentiality is not attained by conventional P2P (peer to peer) type file sharing software.

As described above, according to this embodiment, files can be shared using respective personal computers without requiring any special server or file server. Therefore, a work group type file sharing system which can enhance the confidentiality of digital files and data commonly used by members in a work group, and can assure high availability can be provided.

The parameters N and M may be adaptively changed according to the availabilities of nodes (personal computers) of participants and the confidentiality of original data. For example, when there are eight participants of a conference, and three out of the eight members may miss the next conference, N=8 and M=4 can be set as in the example of FIGS. 3 and 4. On the other hand, if only one of the eight members may miss the next conference, N=8 and M=2 can be set.

In a conference with a rule that stipulates a majority of members must actually attend, a reference (data) of that conference may be quadruply distributed and delivered to eight members in advance, and when five or more members attend the conference, they can open the reference (data) of the conference delivered in advance. In this way, since the reference of the conference cannot be opened if the number of participants does not meet the condition of the rule, the reference cannot be changed against the rule.

### SECOND EMBODIMENT

### Backup of Server

In, e.g., regular maintenances of department servers installed in departments or bases of minor and major companies, data needs to be temporarily backed up and saved in physically different locations in some cases. However, data saving (storage) space cannot often be assured due to insufficient free space of hard disks of other servers in the departments.

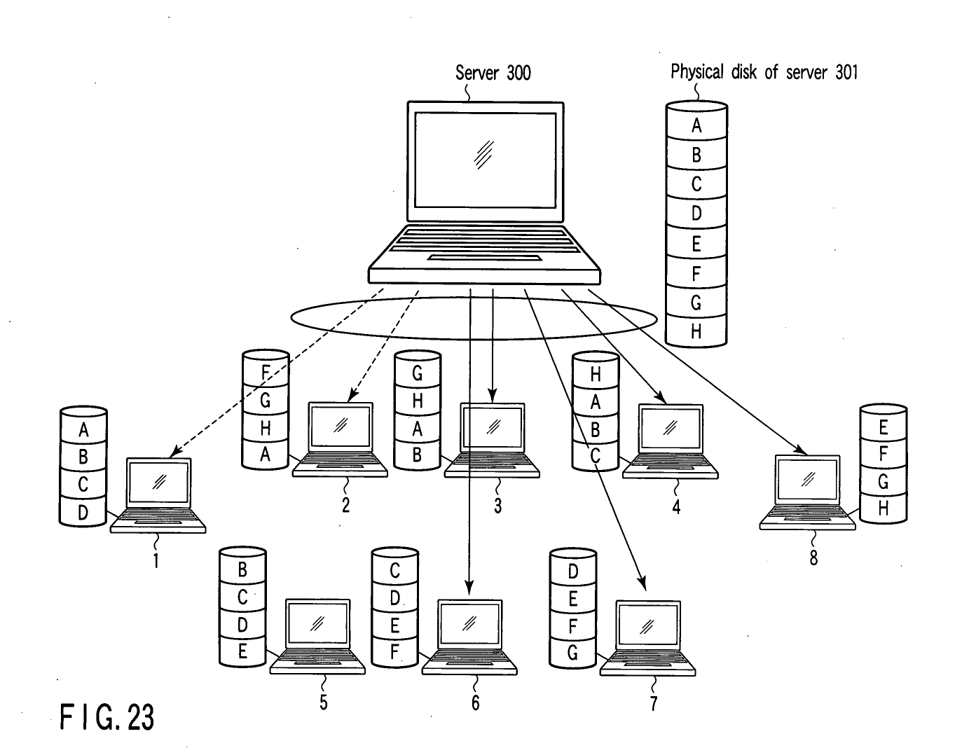

This embodiment can be used to solve the aforementioned problem. As shown in FIG. 23, N personal computers connected to a network of a department provide some free hard disk space. Data to be backed up in a physical disk 301 of a server 300 is divided into N data, which are sequentially M-fold distributed to and stored in the N personal computers. In this way, after the regular maintenance or the like, (N−M+1) out of the N personal computers need only be made available to restore the data, thus supporting the operational management of the server.

### THIRD EMBODIMENT

### Fail-over by Plural Servers

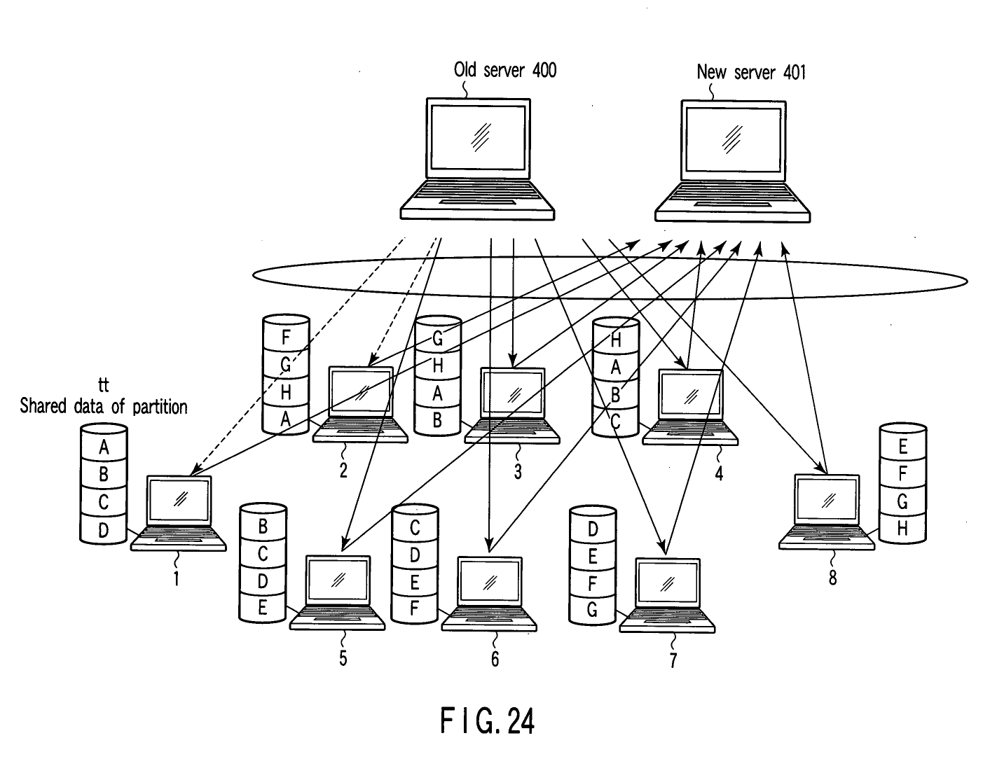

In IT centers of major companies, data centers that provide services on the Internet, and the like, a plurality of servers and a shared disk apparatus used by these servers to share data and memories are prepared, and a fail-over function (that allows another alternative server to inherit processing of services and data) is required in case of failures, regular maintenances, and the like of servers. Using this embodiment, as shown in FIG. 24, the free disk space of N servers (or personal computers) 1 to 8 is provided to configure a virtual shared disk, and data can be M-fold distributed and stored in a plurality of virtual servers.

In this way, even when a main server 400 and arbitrary (M−2) servers have suddenly gone down at the same time, the remaining (N−M+1) servers 1 to 8 can maintain data. When any of the (N−M+1) servers 1 to 8 inherit services, the services can be prevented from being suspended. Upon substitution of the (N−M+1) servers 1 to 8 for the services of the server 400, the system performance may drop. However, a new server 401 is connected to the network, and data is stored from the (N−M+1) servers 1 to 8 in the new server 401, thus obtaining service performance equal to or higher than that of the old server 400.

### FOURTH EMBODIMENT

### Access Control of Confidential Information

Paying attention to the aforementioned principle: when original information is divided into N pieces of information, and M out of N pieces of divided information are distributed to and stored in each of N nodes, if (N−M+1) or more nodes are available, the original information can be restored, such principle can be applied to a distributed authentication system.

For example, as for specific confidential information used in an office, encryption key data used to encrypt that confidential information may be divided into N data without dividing the confidential information itself, unlike in the first embodiment, and the N data may be M-fold distributed to and stored in N information processing apparatuses (personal computers, USB memories, hard disks, and the like). A company member needs to acquire the divided data of the encryption key from (N−M+1) or more information processing apparatuses (personal computers, USB memories, hard disks, and the like.) so as to decode and read out the encrypted confidential information. In this way, the security level of the confidential information can be increased.

When the node set as a master secedes from the network in the aforementioned system, such node transfers the role of the master in accordance with, e.g., an order set in advance. Alternatively, the node set as the master before secession may search for a node with a lighter load based on “Node Availability Info”, and may transfer the role of the master to a node with the lightest load.

Note that the invention is not limited to the aforementioned embodiments intact, and can be embodied by modifying required constituent elements without departing from the scope of the invention when it is practiced. By appropriately combining a plurality of required constituent elements disclosed in the embodiments, various inventions can be formed. For example, some of all the required constituent elements disclosed in the embodiments may be deleted. Furthermore, required constituent elements in different embodiments may be appropriately combined.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information communication system in which a plurality of nodes that belong to a self group are connected to a network,
each of the plurality of nodes comprising:
a node confirmation unit configured to send, via the network, a node confirmation request to remaining nodes to confirm availabilities of the remaining nodes that belong to the self group, and to receive node confirmation response messages including information indicating the availabilities from the remaining nodes;
a node confirmation response message sending unit configured to send, when the node confirmation request is received from the node confirmation unit of another node, the node confirmation response message to the node that sent the node confirmation request;
a distributed storage setting unit configured to set parameters N and M in accordance with contents of the node confirmation response messages;
a distributed storage unit configured to divide shared data into N divided data, and to M-fold distribute and store the divided data of the shared data in N nodes;
a divided data collection unit configured to selectively collect N divided data from not less than (N−M+1) nodes;
a divided data transfer unit configured to transfer, in response to a request from the divided data collection unit of another node, divided data to the node that issued the request; and
a data restoration unit configured to restore the shared data by combining the collected N divided data.

2. A system according to claim 1, wherein the distributed storage setting unit determines the parameters N and M using the contents of the node confirmation response messages and a degree of confidentiality of the shared data.

3. A system according to claim 1, wherein the node confirmation response message includes a recording capacity available in a self node.

4. A system according to claim 1, wherein each node further comprises an authentication unit configured to authenticate a user or an apparatus of a node that made access, and
the divided data transfer unit transfers the divided data when authentication by the authentication unit has succeeded.

5. A system according to claim 1, wherein each node is an information processing apparatus on which a first operating system and first software including a first program group that runs on the first operating system, and a second operating system and second software including a second program group that runs on the second operating system run at the same time, and
the node further comprises a unit configured to inhibit direct accesses from the first software to resources in the second software.

6. A system according to claim 5, wherein the respective divided data, the node confirmation unit, the node confirmation response message sending unit, the distributed storage unit, the divided data transfer unit, and the data restoration unit belong to the second software.

7. A system according to claim 5, wherein the distributed storage setting unit belongs to the second software.

8. A data sharing method for an information communication system in which a plurality of nodes that belong to a self group are connected to a network, the method comprising:
sending, via the network, a node confirmation request to remaining nodes to confirm availabilities of the remaining nodes that belong to the self group;
receiving node confirmation response messages including information indicating the availabilities from the remaining nodes;
setting parameters N and M in accordance with contents of the node confirmation response messages;
dividing shared data into N divided data, and M-fold distributing and storing the divided data of the shared data in N nodes;
selectively collecting N divided data from not less than (N−M+1) nodes; and
restoring the shared data by combining the collected N divided data.

9. A method according to claim 8, wherein the parameters N and M are determined using the contents of the node confirmation response messages and a degree of confidentiality of the shared data.

10. A method according to claim 8, wherein the node confirmation response message includes a recording capacity available in a self node.

11. A method according to claim 8, which further comprises, upon selectively collecting the N divided data:
sending a request to transfer divided data to another node; and
transferring, from the node that received the request, the divided data according to the request, to the node that sent the request.

12. A method according to claim 11, which further comprises:
executing authentication processing between the node that sent the request and the node that received the request; and
transferring, when the authentication processing has succeeded, the divided data according to the request from the node that received the request to the node that sent the request.

13. A method according to claim 8, wherein each node is an information processing apparatus on which a first operating system and first software including a first program group that runs on the first operating system, and a second operating system and second software including a second program group that runs on the second operating system run at the same time, and
the node further comprises a unit configured to inhibit direct accesses from the first software to resources in the second software.

14. A method according to claim 13, wherein the respective divided data belong to the second software.
